(19) United States
(12) Patent Application Publication
(10) Pub. No.: US 2014/0359172 A1
(43) Pub. Date: Dec. 4, 2014

(54) ELECTRONIC DEVICE WITH CEC FUNCTION AND CONTROLLING METHOD THEREOF

(71) Applicants: HON HAI PRECISION INDUSTRY CO., LTD., New Taipei (TW); HONG FU JIN PRECISION INDUSTRY (Shenzhen) CO., LTD, Shenzhen (CN)

(72) Inventors: YANG WANG, Shenzhen (CN); JUN-JUAN GAO, Shenzhen (CN); XIAO-WEI YANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 14/140,296

(22) Filed: Dec. 24, 2013

(30) Foreign Application Priority Data
May 30, 2013 (CN) 2013102079333

(51) Int. Cl. G06F 13/10

(52) U.S. Cl. CPC G06F 13/10
USPC 710/18

(57) ABSTRACT

An electronic device connected to an external device is capable of switching between a first state and a second state. The electronic device comprises a communication module, a detection module, a control module, and a processor. The communication module receives different control commands from the external device. The detection module detects whether the electronic device is in the first state or the second state, and generates corresponding signals. The control module enables or disables the processor in response to the corresponding signals and executes a corresponding operation corresponding to the received control commands

### BACKGROUND

1. Technical Field

The present disclosure relates to electronic devices, particularly to an electronic device with a CEC function.

2. Description of Related Art

An electronic device connected to an external device through a high definition multimedia interface (HDMI) interface is capable of switching between a power-on state and a power-off state, and a processor of the electronic device executes received consumer electronic control (CEC) commands from the external device. However, when the electronic device is in the power-off state, the processor is disabled and cannot execute the received CEC commands.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the electronic device and method thereof Moreover, in the drawings, like reference numerals designate corresponding parts throughout the several views.

FIG. 1 is a block diagram of an embodiment of an electronic device.

FIG. 2 is a flowchart of an embodiment of a method for controlling the electronic device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

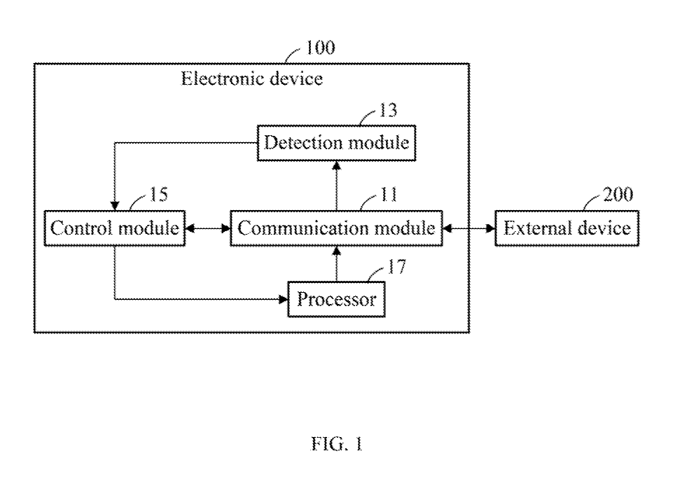

FIG. 1 shows an embodiment of an electronic device 100. The electronic device 100 is connected with an external device 200 through a high definition multimedia interface (HDMI) interface, and is capable of switching between a first state and a second state. The electronic device 100 receives different control commands from the connected external device 200 to execute a corresponding operation. In one embodiment, the electronic device 100 is a DVD player, and the external device 200 is a TV. The first state can be a power-off state or a standby state, and the second state can be a power-on state. The control command is a consumer electronic control (CEC) command, such as one a touch play command, a system record command, a one touch record command, a system information command, or a system standby command.

The electronic device 100 includes a communication module 11, a detection module 13, a control module 15, and a processor 17.

The communication module 11 is used for communicating with the external device 200. The communication module 11 further generates a detecting signal when the communication module 11 receives the control command from the external device 200, and outputs the received control command to the control module 15.

The detection module 13 is connected to the communication module 11. The detection module 13 is used for detecting whether the electronic device 100 is in the first state or the second state. When the electronic device 100 is in the first state, the detection module 13 generates a first state signal, and sends the first state signal to the control module 15. When the electronic device 100 is in the second state, the detection module 13 generates a second state signal, and sends the second state signal to the control module 15.

The control module 15 controls the processor 17 to be disabled in response to receiving the first state signal, and executes an operation corresponding to received control commands from the external device 200. The control module 15 further controls the processor 17 to be enabled in response to receiving the second state signal, and transmits the received control commands to the processor 17. In the embodiment, the control module 15 is a micro control unit (MCU), and the processor 17 is an audio code/decode chip.

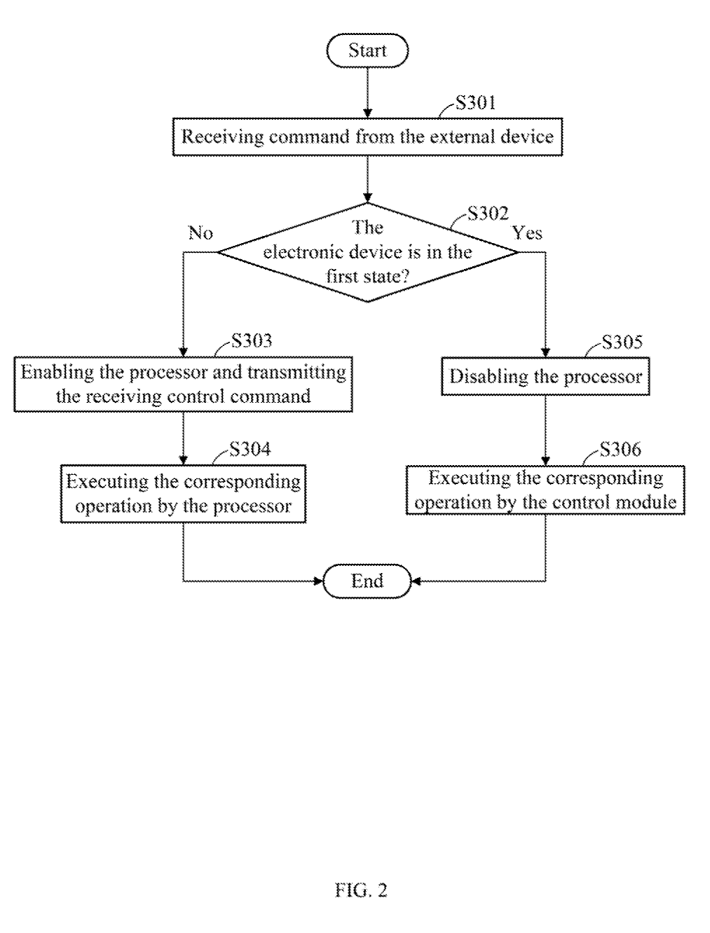

FIG. 2 shows an embodiment of a method applied to the electronic device 100 for controlling the external device 200 through an HDMI interface. The electronic device 100 is capable of switching between a first state and a second state, and receiving different control commands from the connected external device 200 to execute a corresponding operation. The method includes the following steps.

In step S301, the communication module 11 receives the control commands from the external device 200.

In step S302, the detection module 13 detects whether the electronic device 100 is in the first state. If the electronic device 100 is in the first state, a first state signal is generated, and the procedure goes to S303. If the electronic device 100 is in the second state, a second state signal is generated, and the procedure goes to S305.

In step S303, in response to receiving the first state signal, the control module 15 controls the processor 17 to be disabled. In one embodiment, the control module 15 is a micro control unit (MCU), and the processor 17 is an audio code/decode chip.

In step S304, the control module 15 executes an operation corresponding to the received control commands.

In step S305, in response to receiving the second state signal, the control module 15 controls the processor 17 to be enabled, and transmits the received CEC commands to the processor 17.

In step S306, the processor 17 executes an operation corresponding to the received control commands.

In use, no matter which state the electronic device 100 is in, the electronic device 100 executes an operation corresponding to a received CEC command from the external device 200.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. An electronic device connected to an external device; the electronic device capable of switching between a first state and a second state; the external device capable of outputting different control commands to the electronic device; the electronic device comprising:
a communication module for communicating with the external device and generating a detecting signal;
a detection module for detecting whether the electronic device is in the first state when receiving control commands from the external device in response to the detecting signal;
a control module connected to the communication module, and capable of receiving control commands from the communication module; and
a processor connected to the control module, and capable of executing a corresponding operation corresponding to the received control command;
wherein when the electronic device is in the first state, the detection module generates a first state signal and transmits the first signal to the control module, the control module disables the processor and executes a corresponding operation corresponding to the received control command.

2. The electronic device of claim 1, wherein the electronic device is in the second state, the detection module generates a second state signal, the control module enables the processor and transmits the received control command to the processor, the processor executes a corresponding operation corresponding to the received control command.

3. The electronic device of claim 1, wherein the control command is a consumer electronic control (CEC) command.

4. The electronic device of claim 1, wherein the electronic device connects with the external device through high definition multimedia interface (HDMI) interface.

5. The electronic device of claim 1, wherein the control module is a micro control unit (MCU); the processor is a code/decode chip.

6. A controlling method applied to an electronic device connected to an external device; the electronic device capable of switching between a first state and a second state; the external device capable of outputting different control commands to the electronic device; the electronic device comprising a control module and a processor connected to the control module; the controlling method comprising:
receiving a control command from the external device;
detecting whether the electronic device is in the first state;
generating a first state signal when the electronic device is in the first state;
disabling the processor; and
executing a corresponding operation by the control module corresponding to the control command.

7. The controlling method of claim 6, wherein when the electronic device is in the second state, generating a second state signal;
enabling the processor; and
executing a corresponding operation by the processor corresponding to the control command.

8. The controlling method of claim 6, wherein the control command is a consumer electronic control (CEC) command.

9. The controlling method of claim 6, wherein the electronic device connects with the external device through high definition multimedia interface (HDMI) interface.

10. The controlling method of claim 6, wherein the control module is a micro control unit (MCU); the processor is a code/decode chip.
